(19) United States
(12) Patent Application Publication
(10) Pub. No.: US 2010/0134471 A1
(43) Pub. Date: Jun. 3, 2010

(54) Output driving circuits of output buffers for source driver integrated circuits

(75) Inventors: Ki-Won Seo, Seoul (KR); Jae-Wook Kwon, Yongin-si (KR); Do-Yun Kim, Hwaseong-si (KR); Sung-Pil Choi, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/591,482

(22) Filed: Nov. 20, 2009

(30) Foreign Application Priority Data
Nov. 28, 2008 (KR) 10-2008-0119271

(51) Int. Cl. G09G 5/00

(52) U.S. Cl. 345/212; 345/214

(57) ABSTRACT

An output driving circuit is provided that may reduce power consumption by decreasing static current leakage in a liquid crystal display device. The output driving circuit of an output buffer of a source driver integrated circuit may include: an output driving unit including a pull-up transistor and a pull-down transistor coupled to a source line driving signal output terminal; and a sub output driving unit configured to perform an output driving operation together with the output driving unit during a normal operation period of an active horizontal synchronization signal and configured to be disabled during a period in which the horizontal synchronization signal is inactive in response to a control signal, in order to reduce static current leakage flowing through the output driving circuit. Current leakage is reduced in the inactive period of a horizontal synchronization signal in an output driving circuit, thereby reducing power consumption of a liquid crystal display device.

### PRIORITY STATEMENT

This application claims priority under 35 U.S.C. §119 to Korean Patent Application 10-2008-0119271, filed on Nov. 28, 2008, the contents of which are hereby incorporated by reference in their entirety as if fully set forth herein.

### BACKGROUND

1. Field

Example embodiments relate to a source driver of a liquid crystal display, and more particularly, to an output driving circuit of an output buffer of a source driver integrated circuit.

2. Description of the Related Art

Thin film transistor liquid crystal displays (TFT-LCD) are widely used in medium to small sized applications. For example, TFT-LCDs may be used in applications requiring portability, such as notebook computers, PMPs and/or PDAs. Required characteristics of TFT-LCDs in portable applications may include miniaturized components, thin films, and decreased power consumption. A liquid crystal display (LCD) of an active matrix type using a thin film transistor as a switching device is known in the field to be adequate to display moving images.

An active matrix LCD device may include a liquid crystal panel, source drivers (SD), each of which may include a plurality of source lines (SL), and gate drivers (GD), each of which may each include a plurality of gate lines (GL). A source line may be a data line or channel. Each source driver may drive source lines in the liquid crystal panel. Each gate driver may drive gate lines in the liquid crystal panel.

The liquid crystal panel may include a plurality of pixel units. Each pixel unit may include a switch transistor (TR), a storage capacitor (CST) and a liquid crystal capacitor (CLC). The switch transistor may switch on or off in response to a gate line signal and a first terminal of the switch transistor may be coupled to a source line. The storage capacitor, which may reduce current leakage from a liquid crystal, may be coupled between a second terminal of the switch transistor and ground. The liquid crystal capacitor may be coupled between the second terminal of the switch transistor and a common voltage (VCOM).

The source driver of the liquid crystal device may include digital-to-analog converters (DACs), output buffers, output switches and a charge sharing switch. Each DAC may convert digital image signals into analog image signals and output the analog image signals. Each analog image signal may indicate a gray level voltage. Each output buffer may correspond to a digital-to-analog converter and output amplified analog image signals which may be transferred to a corresponding output switch. The output switch may output an amplified analog image signal as a source line driving signal, in response to an output switch control signal. The source line driving signal may be supplied to a load (LD) coupled to a source line. The load may be modeled by using parasitic capacitors and parasitic resistances coupled in a ladder-type model.

The charge sharing switch may pre-charge a driving signal to a pre-charge voltage level by sharing charges stored in loads coupled to all source lines, in response to a sharing switch control signal. When voltage polarities of adjacent source line driving signals have mutual opposite polarities, for example, a voltage of first source line driving signal is a positive polarity between VDD and VDD/2 and a voltage of second source line driving signal is a negative polarity between VDD/2 and a ground voltage VSS, the pre-charge voltage may be VDD/2. This charge sharing method may be principally used by a source driver for driving a large-sized liquid crystal panel, to reduce the current supply burden of the output buffers. The charge sharing switch pre-charges all source line driving signals to VDD/2 for a charge sharing time before an output switch is turned on. The voltage of the all source line driving signals is precharged to VDD/2 after which the turned-on output switch supplies a load with a source line driving signal amplified by an output buffer.

The requirements for current consumption reduction are increased in recent TFT-LCD applications. In developing small and medium-sized panels starting from large-sized panel technology, the current consumption of the source driver IC increases in significance. Accordingly, measurements of current consumption reduction in an output buffer of the IC increase in importance.

### SUMMARY

Example embodiments provide an output driving circuit for use in an output buffer of a source driver integrated circuit. Power consumption of the output buffer can be reduced.

According to an example embodiment, an output driving circuit of an output buffer of a source driver integrated circuit is provided, the circuit including: an output driving unit including a pull-up transistor and a pull-down transistor coupled to an output terminal, the output terminal configured to output a source line driving signal; and a sub output driving unit configured to perform an output driving operation together with the output driving unit while a horizontal synchronization signal is active, and to be disabled and not perform an output driving operation in response to a control signal applied while the horizontal synchronization signal is inactive, a static leakage current of the output driving circuit being reduced while the sub output driving unit is disabled.

According to an example embodiment, an output driving circuit of an output buffer of a source driver integrated circuit of a liquid crystal display device is provided, the circuit including: a pull-up transistor including, a first channel region coupled to a power voltage terminal and an output terminal, and a first gate coupled to a pull-up signal line;

a pull-down transistor including, a second channel region coupled to the output terminal and a ground voltage terminal, and a second gate coupled to a pull-down signal line; a sub pull-up output driving unit including a third channel region coupled in parallel to the pull-up transistor between the power voltage terminal and the output terminal, the sub pull-up output driving unit configured to perform a pull-up operation together with the pull-up transistor during a normal operation period in which a horizontal synchronization signal is active and configured to be disabled in response to a first control signal applied during a period in which the horizontal synchronization signal is inactive, a combined leakage current through the first and third channels being reduced during a period in which the sub pull-up output driving unit is disabled; and a sub pull-down output driving unit including a fourth channel region coupled in parallel to the pull-down transistor between the output terminal and the ground voltage terminal, the sub pull-down output driving unit configured to perform a pull-down operation together with the pull-down transistor in the normal operation period, and being disabled in response to a second control signal applied during a period in which the horizontal synchronization signal is inactive, a combined leakage current through the second and fourth channels being reduced during a period in which the sub pull-down output driving unit is disabled.

According to an example embodiment, a method of driving an output buffer output of a source driver integrated circuit of a liquid crystal display device is provided, the method including: driving, at the same time, during a normal operation period defined by an active horizontal synchronization signal, at least one pull-up transistor and at least one pull-down transistor, at least one of the at least one pull-up transistor and the at least one pull-down transistor is a plurality of split transistors, each of the pull-up and pull-down transistors coupled to an output terminal, and driving less than all of the pull-up and pull-down transistors during a leakage current cutoff period defined by an inactive horizontal synchronization signal, in order to reduce a leakage current level.

According to an example embodiment, an output driving circuit is provided, including: at least one pull-up transistor, connected between an output terminal and a first voltage terminal; at least one pull-down transistor, connected between the output terminal and a second voltage terminal; at least one switch, connected between a gate of one of the at least one pull-up transistor and the at least one pull-down transistor and a corresponding pull-up or pull-down signal line; and at least one cutoff MOS transistor coupled to the switch and the gate.

### BRIEF DESCRIPTION OF THE DRAWINGS

Example embodiments will be more clearly understood from the following brief description taken in conjunction with the accompanying drawings. FIGS. 1-6 represent non-limiting, example embodiments as described herein.

FIG. 1 is a circuit diagram of an output buffer according to the conventional art;

FIG. 2 is a circuit diagram illustrating static leakage current in an output driving circuit of the conventional output buffer of FIG. 1;

FIG. 3 is a timing diagram illustrating timing of generation operations of general vertical and horizontal synchronization signals and control signals according to an example embodiment;

FIG. 4 is a circuit diagram of an output buffer according to an example embodiment;

FIG. 5 is a circuit diagram illustrating the output driving circuit of FIG. 4; and

FIG. 6 is a table displaying an EDS test result of the circuit shown in FIG. 4.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

An output driving circuit for use in an output buffer of a source driver integrated circuit according to example embodiments is described below with reference to the accompanying drawings. Detailed descriptions of manufacturing processes of liquid crystal displays, the function of source driver ICs, output buffering operations of output buffers and general internal circuits are omitted for clarity.

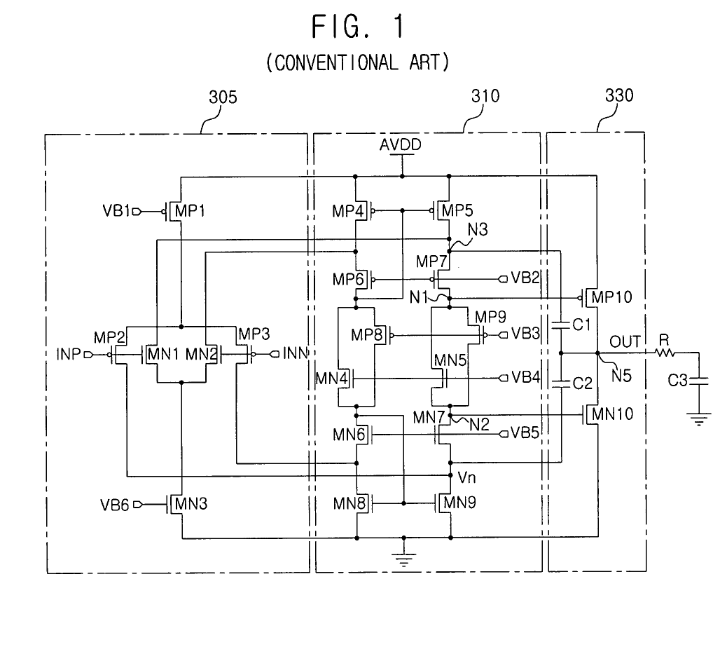

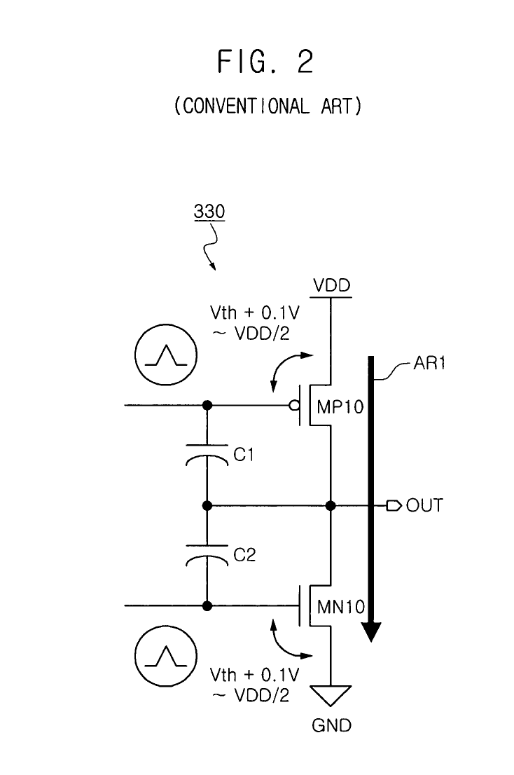

An output buffer circuit and static leakage current in an output driving circuit according to the conventional art will now be described with reference to FIGS. 1 and 2. FIG. 1 is a circuit diagram of an output buffer according to the conventional art. FIG. 2 is a circuit diagram illustrating static leakage current in an output driving circuit of the conventional output buffer of FIG. 1.

A TFT-LCD crystal is polar and in a 1-dot inversion drive, the polarity of display data may be changed for a horizontal synchronization period of the TFT-LCD. From a source driver IC point of view, gamma polarity may be changed for the horizontal synchronization ‘zero’ period. During the zero period, data lines of the TFT-LCD are short-circuited between adjacent odd and even lines to share charge and consequently reduce consumption current.

Referring to FIG. 1, an example of an output buffer circuit used in a source driver IC is shown with a rail-to-rail type operational amplifier circuit structure. The output buffer of FIG. 1 may include an input unit 305, an amplification unit 310 and an output unit 330. The output buffer is shown in a voltage follower configuration, where an output signal OUT is fed back as an inversion input signal of input signals INP and INN.

Referring to the input unit 305, a first input signal INP of the input unit 305 may be an analog image signal and a second input signal INN may be a source line driving signal. The input unit 305 may comprise PMOS transistors MP1-MP3 and NMOS transistors MN1-MN3. The input unit 305 may receive the first input signal INP and the second input signal INN, having a mutual complementary correlation. A first bias voltage VB1 may be applied to the gate of the first PMOS transistor MP1 and a sixth bias voltage VB6 may be applied to the gate of the third NMOS transistor MN3.

The amplification unit 310 may be configured in a folded cascode type configuration and may include PMOS transistors MP4-MP9 and NMOS transistors MN4-MN9. The amplification unit 310 may receive output signals of the input unit 305 in order to amplify the input signals INP and INN. A second bias voltage VB2 may be applied to the gates of the sixth and seventh PMOS transistors MP6 and MP7. A third bias voltage VB3 may be applied to the gates of the eighth and ninth PMOS transistors MP8 and MP9. A fourth bias voltage VB4 may be applied to the gates of the fourth and fifth NMOS transistors MN4 and MN5. A fifth bias voltage VB5 may be applied to the gates of the sixth and seventh NMOS transistors MN6 and MN7. The fourth to seventh PMOS transistors MP4-MP7 may constitute a first current mirror circuit and the sixth to ninth NMOS transistors MN6-MN9 may constitute a second current mirror circuit. The eighth and ninth PMOS transistors MP8 and MP9 and the fourth and fifth NMOS transistors MN4 and MN5 may control the amount of current flowing through a tenth PMOS transistor MP10 of the output unit 330 and/or a current amount flowing through a tenth NMOS transistor MN10 of the output unit 330.

The output unit 330 may include PMOS transistor MP10 and NMOS transistor MN10. The output unit 330 may generate an output signal OUT of the output buffer through an output node N5 by receiving signals of output nodes N1 and N2 of the amplification unit 310. The output signal OUT may be a source line driving signal. The output unit 330 may include two capacitors C1 and C2 to stabilize frequency characteristics of the output signal OUT. The capacitors C1 and C2 may prevent and/or reduce oscillation of the output signal OUT of the output buffer and may be called a Miller compensation capacitor. A slew rate (SR) of the output voltage of the output buffer may be provided as dVout/dt=(IMP1+IMN3)/2C, where Vout is the output voltage of the output buffer, IMP1 is the amount of current flowing through a first PMOS transistor MP1, IMN3 is the amount of current flowing through a third NMOS transistor MN3, and C is the capacitance of capacitor C.

Referring to FIG. 2, a static current path AR1 is provided for the voltage follower configuration. The voltage of the gate/source of PMOS transistor MP10 and NMOS transistor MN10 may be maintained at a threshold voltage or greater. The PMOS transistor MP10 and the NMOS transistor MN10 may be kept in an on state and a static current may be consumed through the current path. According to the conventional art, a leakage current continuously flows through the current path AR1 while a TFT-LCD panel performs a display operation. Although a class AB operational amplifier theoretically has a static leakage current of a low enough level that it may be disregarded, an increased current may flow in a voltage follower of a TFT-LCD source driver IC relative to the conventional art. For this reason, a capacitive load of TFT-LCD panel in portable applications (e.g., notebook computers) may be hundreds of pico farads or greater.

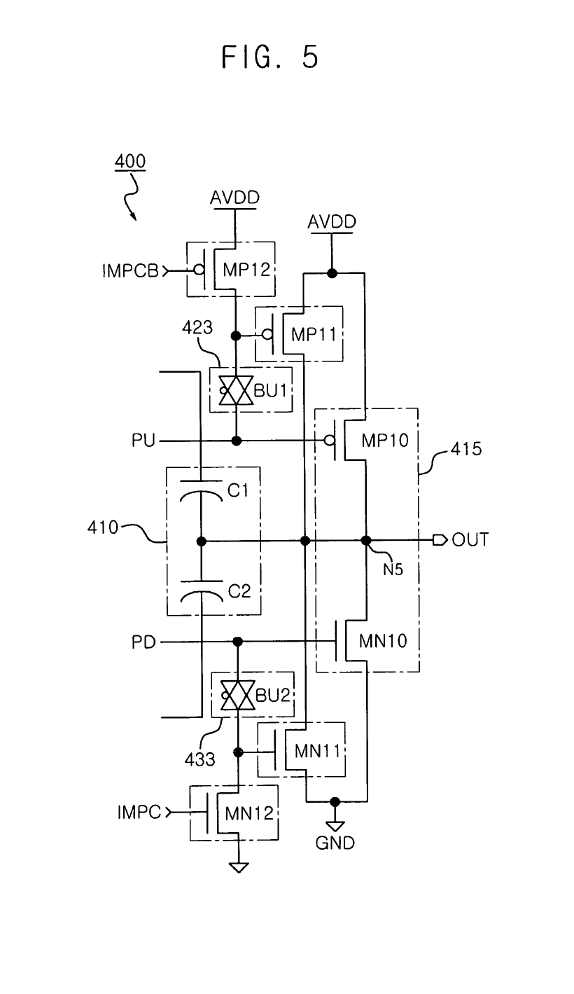

Static leakage current may be substantially reduced by employing an output driving circuit according to example embodiments, for example, an embodiment according to FIG. 5. Consumed power of the source driver IC employing an output buffer according to example embodiments can be reduced by reducing the static current of the output driving circuit.

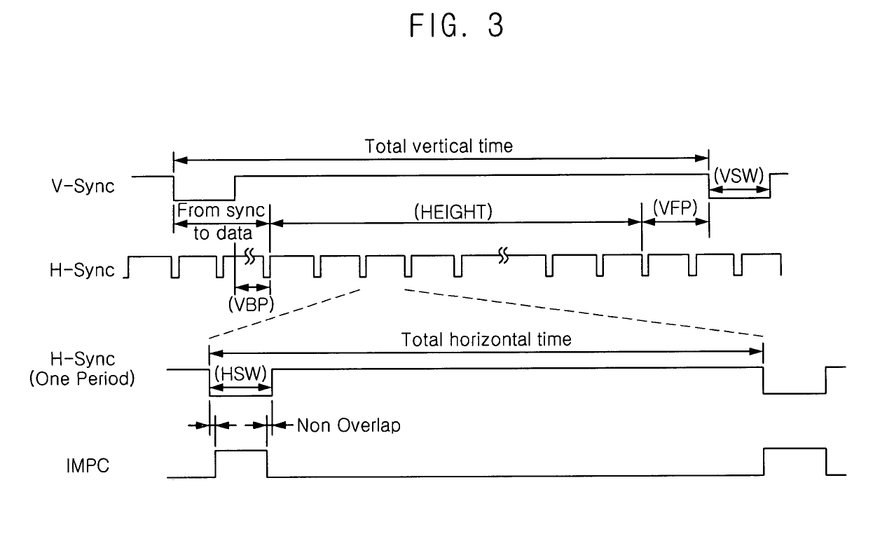

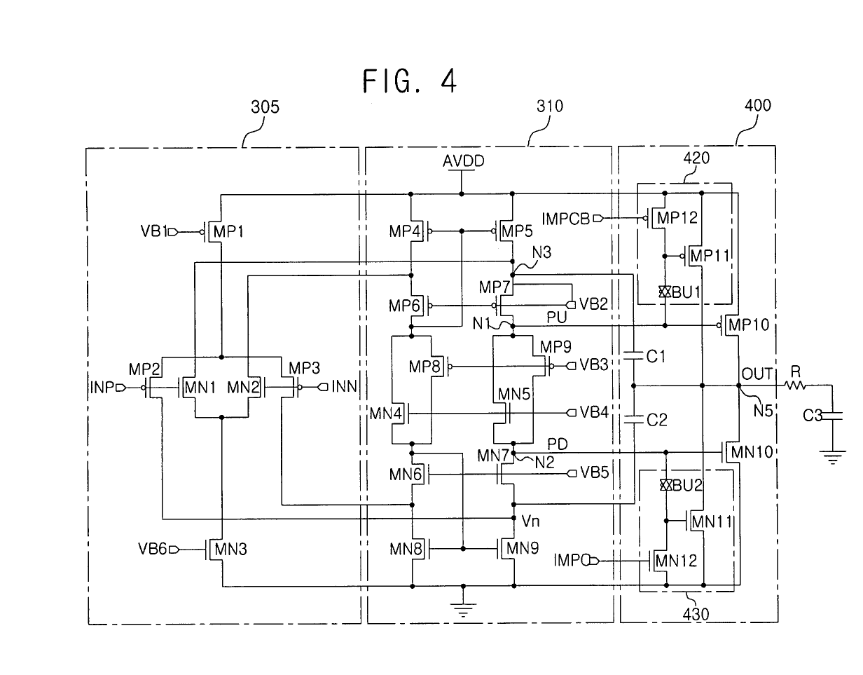

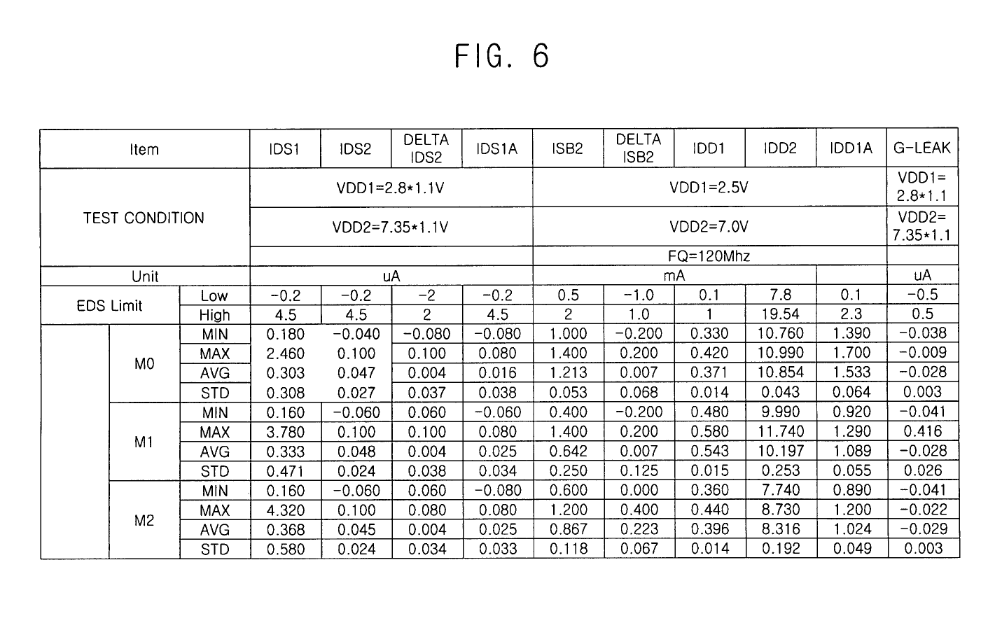

FIG. 3 is a timing diagram illustrating timing for generation operations of general vertical and horizontal synchronization signals and control signals according to an example embodiment. FIG. 4 is a circuit diagram of an output buffer according to an example embodiment. FIG. 5 is a circuit diagram illustrating the output driving circuit of FIG. 4. FIG. 6 is a table displaying an EDS test result of the circuit shown in FIG. 4. The principle of operation of the circuit shown in FIGS. 4 and 5 may include output impedance control during an inactivation period of the horizontal synchronization signal of the TFT-LCD panel.

Referring to FIG. 4, the output buffer may include an input unit 305, an amplification unit 310 and an output unit 400. Similarly to FIG. 1, the output buffer may have a voltage follower configuration in which an output signal OUT may be fed back as an inversion input signal of input signals INP and INN. Referring to input unit 305, a first input signal INP of the input unit 305 may be an analog image signal and a second input signal INN may be a source line driving signal. The input unit 305 may include PMOS transistors MP1-MP3 and NMOS transistors MN1-MN3. The input unit 305 may receive the first input signal INP and the second input signal INN having a mutual complementary correlation. A first bias voltage VB1 may be applied to the gate of the first PMOS transistor MP1 and a sixth bias voltage VB6 may be applied to the gate of the third NMOS transistor MN3.

Similarly to FIG. 1, the amplification unit 310 may be configured in a folded cascode type configuration. Referring to FIG. 4, the amplification unit 310 may include PMOS transistors MP4-MP9 and NMOS transistors MN4-MN9. The amplification unit 310 may receive output signals of the input unit 305 in order to amplify the input signals INP and INN. Second bias voltage VB2 may be applied to the gates of the sixth and seventh PMOS transistors MP6 and MP7. Third bias voltage VB3 may be applied to the gates of the eighth and ninth PMOS transistors MP8 and MP9. Fourth bias voltage VB4 may be applied to the gates of fourth and fifth NMOS transistors MN4 and MN5. Fifth bias voltage VB5 may be applied to gates of sixth and seventh NMOS transistors MN6 and MN7. The fourth to seventh PMOS transistors MP4-MP7 may constitute a first current mirror circuit and the sixth to ninth NMOS transistors MN6-MN9 may constitute a second current minor circuit. The eighth and ninth PMOS transistors MP8 and MP9 and the fourth and fifth NMOS transistors MN4 and MN5 may control the amount of current flowing through the tenth PMOS transistor MP10 of the output unit 400 and/or a current amount flowing through a tenth NMOS transistor MN10 of the output unit 400.

The output unit 400 may include PMOS transistors MP10-MP12 and NMOS transistors MN10-MN12. The output unit 400 may generate output signal OUT of the output buffer at output node N5 by receiving signals of output nodes N1 and N2 of the amplification unit 310. The output signal OUT may be a source line driving signal to drive a source line. The output unit 400 may include two capacitors C1 and C2 to stabilize frequency characteristics of the output signal OUT. The capacitors C1 and C2 may prevent and/or reduce oscillation of the output signal OUT of the output buffer and may be called a miller compensation capacitor. A slew rate (SR) of the output voltage of the output buffer may be provided as dVout/dt=(IMP1+IMN3)/2C, where Vout is the output voltage of the output buffer, IMP1 is the amount of current flowing through a first PMOS transistor MP1, IMN3 is the amount of current flowing through a third NMOS transistor MN3, and C is the capacitance of capacitor C.

The principle that static current of a voltage follower may be reduced depending upon a size determination rate of split transistors will now be described with reference to FIGS. 1 and 5. The PMOS transistor MP10 of FIG. 1 may be split into PMOS transistor MP10 and PMOS transistor MP11 as illustrated in FIG. 5. The NMOS transistor MN10 of FIG. 1 may be split into NMOS transistors MN10 and MN11 as illustrated in FIG. 5. The current load may be shared between the split transistors. For example, assuming that the size of PMOS transistor MP10 shown in FIG. 1 is 100 and that the size determination rate for the PMOS transistors MP10 and MP11 of FIG. 5 is 50:50, when the PMOS transistor MP11 of FIG. 5 is turned off and the PMOS transistor MP10 alone has a turn-on state, the leakage current may be reduced by 50%. When the split NMOS transistor MN11 is turned off, leakage current flowing through the NMOS transistor MN10 may also reduced.

The PMOS transistor MP11 and the NMOS transistor MN11 may be controlled in such a manner as to respectively perform pull-up and pull-down operations during normal operation and may be disabled in order to reduce the static leakage current during an inactivation period of the horizontal synchronization signal. The gate of the PMOS transistor MP11 may be connected between a switching unit 423 for switching the pull up signal PU and a PMOS transistor MP12 which may respond to a control signal IMPCB in order to disable the PMOS transistor MP11. Similarly, the gate of the NMOS transistor MN11 may be connected between a switching unit 433 and the NMOS transistor MN12, the switching unit 433 switching a pull down signal PD and the NMOS transistor MN12 disabling operation of the NMOS transistor MN11 in response to a control signal IMPC.

Referring to FIGS. 3 and 5, the pull-up transistor MP10 and the pull-down transistor MN10 may be coupled to an output terminal OUT to output a source line driving signal and may constitute an output driving unit 415. The PMOS transistor MP11 and the NMOS transistor MN11 may perform an output driving operation together with the output driving unit 415 during a normal operation period of a horizontal synchronization signal H-Sync that is activated in an H period, and may be disabled in response to a control signal (IMPC of FIG. 3) applied during a period in which the horizontal synchronization signal H-Sync is inactive. The PMOS transistor MP11 and the NMOS transistor MN11 may be disabled in order to perform an operation of a sub output driving unit to reduce the static leakage current flowing through the entire output driving circuit.

According to example embodiments, a source driver IC output buffer may be configured to include transistors MP11 and MN11 that are split-disposed with transistors MP10 and MN10 to form a static current path. When transistors MP11 and MN11 are turned off in a period in which the horizontal synchronization signal is inactive, as shown in the timing diagram of FIG. 3, the static current path may be reduced corresponding to a size determination rate. In the inactive period of the horizontal synchronization signal the charging time of the source driver IC output buffer may not be affected and there may be no difference in display quality as compared to a conventional output buffer.

Switching of the PMOS transistor MP11 and the NMOS transistor MN11 may be controlled by a waveform signal IMPC (shown in FIG. 3) which may be obtained by inverting the horizontal synchronization signal of a TFT-LCD panel. The IMPC signal may be a logic control signal performing a static power cutoff enable (SPCEN). The control signal IMPC may be generated during a non-overlap period Non Overlap of several nanoseconds and thus may not be transitioned with the same timing as that of the horizontal synchronization signal. In a high period of the IMPC signal, transistors MN12 and MP12 of FIG. 5 may be turned on and transistors MP11 and MN11 may be turned off when transmission gates of switching units 433 and 423 are turned off. The output of output driving unit 415 having the voltage follower structure almost transitions to a cutoff state. The static current path may be partially cut off and a current leakage amount can be improved and/or reduced.

In a normal operation period that is a high period of the horizontal synchronization signal, the control signal IMPC may be generated as a logic low level. During this time, the transistors MN12 and MP12 of FIG. 5 may be turned off and the transistors MP11 and MN11 may be turned on when transmission gates of switching units 433 and 423 are turned on, because gates of transistors MP11 and MN11 are connected with a pull-up signal and a pull-down signal. Pull-up operations are together performed by the transistors MP11 and MP10 and pull-down operations are together performed by the transistors MN11 and MN10. Accordingly, the output buffer of FIG. 4 may carry out normal slewing in an impedance state.

In an example embodiment, switching transistors MP12 and MN12 and transmission gates of switching units 423 and 433, which are used to cut off and/or reduce the static current path, may realize a minimum size as compared with the existing structure without causing a size burden. Additionally, when the control signal IMPC is used as the existing charge sharing control signal, a side effect based on an additionally wired signal line can be eliminated.

Table 1 (below) provides HSPICE simulation results of an S6CR029 product implemented using an example embodiment and is compared to a conventional configuration. Current consumption may be reduced an average of 14.4% with a 120 pf EDS load and current consumption may be reduced an average of 4˜8% per pattern with a 150 pf panel load.

TABLE 1

| | | | Current |
|---|---|---|---|
| | Ref. (S6CR029_M0) | S6CR029_M2 | Reduction Rate |
| EDS load | 4.23 mA | 3.62 mA | 14.4% |
| Panel | 7.94 mA | 7.52 mA | 5.3% |
| load (black) | | | |
| Panel | 1.91 mA | 1.75 mA | 8.4% |
| load (white) | | | |
| Panel | 8.64 mA | 8.27 mA | 4.3% |
| load (1 dot) | | | |

TABLE 2

| | S6CR029 | | S6CR029 | | |
|---|---|---|---|---|---|
| | M0 | | M2 | | |
| Display Pattern | 6ea | 1ea | 6ea | 1ea | Current Reduction Rate |
| white | 18 | 3.0 | 16 | 2.7 | 11.1% |
| black | 69 | 11.5 | 67 | 11.2 | 2.9% |
| checker | 18 | 3.0 | 16 | 2.7 | 11.1% |
| hstripe | 18 | 3.0 | 16 | 2.7 | 11.1% |
| vstripe | 18 | 3.0 | 16 | 2.7 | 11.1% |
| subchecker | 60 | 10.0 | 51 | 8.5 | 15.0% |

Table 2 provides a mounting evaluation result of an S6CR029_M2 for a WXGA 17 inch MB4 TFT-LCD panel according to an example embodiment. With reference to Table 2, image quality that may be equal to a conventional configuration may be maintained and current consumption may be reduced an average of 10.3%.

FIG. 6 provides an EDS evaluation of an S6CR029_M2 according to an example embodiment. Power voltage and test frequency are provided in FIG. 6. Referring to FIG. 6, an average EDS result improvement of 23.3% may be obtained.

When receiving improved and/or high resolution, where a raster period of a panel is decreased and the period to control the output buffer having relatively high impedance increases, a relatively greater reduction effect on current consumption can be expected as compared with that of the present embodiment. In a portable application (e.g., notebook computer) the slewing time of an output buffer may be relatively shorter and the charge sharing period may be longer. In this case, the current consumption reduction effect according to example embodiments is expected to be greater.

Although the output buffer 300 according to an example embodiment may be realized in a rail-to-rail operational amplifier, as described above, example embodiments are not so limited. An output driving circuit according to an example embodiment may be applied to two single-operational amplifiers each including an input unit having a structure different from an input unit of a rail-to-rail operational amplifier.

While example embodiments have been particularly shown and described, it will be understood by one of ordinary skill in the art that variations in form and detail may be made therein without departing from the spirit and scope of the claims. It is intended that example embodiments cover modifications and variations within the scope of the claims and their equivalents. For example, according to example embodiments, the number of split transistors or the size determination rate thereof may be changed without deviating form the spirit of the inventive concept. Further, although the output buffer is described above as being applied to a source driver IC, example embodiments include other output circuits consuming a static current.

What is claimed is:

1. An output driving circuit of an output buffer of a source driver integrated circuit, the circuit comprising:
an output driving unit comprising a pull-up transistor and a pull-down transistor coupled to an output terminal, the output terminal configured to output a source line driving signal; and
a sub output driving unit configured to perform an output driving operation together with the output driving unit while a horizontal synchronization signal is active, and to be disabled and not perform an output driving operation in response to a control signal applied while the horizontal synchronization signal is inactive, a static leakage current of the output driving circuit being reduced while the sub output driving unit is disabled.

2. The circuit of claim 1, wherein the sub output driving unit comprises at least one sub pull-up transistor corresponding to the pull-up transistor, and
at least one sub pull-down transistor corresponding to the pull-down transistor.

3. The circuit of claim 2, wherein the sub output driving unit further comprises a switching unit, and
a cutoff MOS transistor,
wherein the switching unit and the cutoff MOS transistor are configured such that the sub pull-up transistor, the sub pull-down transistor, the pull-up transistor and the pull-down transistor are each enabled while a horizontal synchronization signal is active, and the sub pull-up transistor and the sub pull-down transistor are disabled while the horizontal synchronization signal is inactive.

4. The circuit of claim 3, wherein the switching unit comprises a transmission gate.

5. An output driving circuit of an output buffer of a source driver integrated circuit of a liquid crystal display device, the circuit comprising:
a pull-up transistor including, a first channel region coupled to a power voltage terminal and an output terminal, and a first gate coupled to a pull-up signal line;
a pull-down transistor including, a second channel region coupled to the output terminal and a ground voltage terminal, and a second gate coupled to a pull-down signal line;
a sub pull-up output driving unit including a third channel region coupled in parallel to the pull-up transistor between the power voltage terminal and the output terminal, the sub pull-up output driving unit configured to perform a pull-up operation together with the pull-up transistor during a normal operation period in which a horizontal synchronization signal is active and configured to be disabled in response to a first control signal applied during a period in which the horizontal synchronization signal is inactive, a combined leakage current through the first and third channels being reduced during a period in which the sub pull-up output driving unit is disabled; and
a sub pull-down output driving unit including a fourth channel region coupled in parallel to the pull-down transistor between the output terminal and the ground voltage terminal, the sub pull-down output driving unit configured to perform a pull-down operation together with the pull-down transistor in the normal operation period, and being disabled in response to a second control signal applied during a period in which the horizontal synchronization signal is inactive, a combined leakage current through the second and fourth channels being reduced during a period in which the sub pull-down output driving unit is disabled.

6. The circuit of claim 5, wherein the sub pull-up output driving unit comprises a first PMOS transistor that is a split transistor corresponding to the pull-up transistor,
a switching unit configured to couple and decouple a third gate corresponding to the first PMOS transistor and the pull-up signal line, and
a second PMOS transistor configured to be enabled in response to the first control signal to disable operation of the first PMOS transistor.

7. The circuit of claim 6, wherein the sub pull-down output driving unit comprises a first NMOS transistor that is a split transistor corresponding to the pull-down transistor,
a switching unit configured to couple and decouple a fourth gate corresponding to the first NMOS transistor and the pull-down signal line, and
a second NMOS transistor configured to be enabled in response to the second control signal to disable operation of the first NMOS transistor.

8. A method of driving an output buffer output of a source driver integrated circuit of a liquid crystal display device, the method comprising:
driving, at the same time, during a normal operation period defined by an active horizontal synchronization signal, at least one pull-up transistor and at least one pull-down transistor, at least one of the at least one pull-up transistor and the at least one pull-down transistor being a plurality of split transistors, each of the pull-up and pull-down transistors coupled to an output terminal, and
driving less than all of the pull-up and pull-down transistors during a leakage current cutoff period defined by an inactive horizontal synchronization signal, in order to reduce a leakage current level.

9. The method of claim 8, wherein the output terminal outputs a source line driving signal.

10. The method of claim 9, wherein the number of pull-up transistors and pull-down transistors is respectively at least two.

11. An output driving circuit, comprising:
at least one pull-up transistor, connected between an output terminal and a first voltage terminal;
at least one pull-down transistor, connected between the output terminal and a second voltage terminal;
at least one switch, connected between a gate of one of the at least one pull-up transistor and the at least one pull-down transistor and a corresponding pull-up or pull-down signal line; and
at least one cutoff MOS transistor coupled to the switch and the gate.

12. The output driving circuit of claim 11, wherein the at least one switch is connected to the at least one pull-up transistor.

13. The output driving circuit of claim 11, wherein the at least one switch is connected to the at least one pull-down transistor.

14. The output driving circuit of claim 12, wherein the at least one pull-up transistor is a plurality of pull-up transistors that are split transistors sized according to a size determination rate,
the at least one switch is a plurality of switches corresponding to the plurality of pull-up transistors,
the output driving circuit is configured so that during a period in which a horizontal synchronization signal is active the at least one pull-down transistor and the plurality of pull-up transistors are in an on-state and perform a driving operation, and
during a period in which the horizontal signal is inactive, the at least one pull-down transistor and less than all of the pull-up transistors are in the on-state.

15. The output driving circuit of claim 13, wherein the at least one pull-down transistors is a plurality of pull-down transistors that are split transistors sized according to a size determination rate,
the at least one switch is a plurality of switches corresponding to the plurality of pull-down transistors,
the output driving circuit is configured so that during a period in which a horizontal synchronization signal is active the at least one pull-up transistor and the plurality of pull-down transistors are in an on-state and perform a driving operation, and
during a period in which the horizontal signal is inactive, the at least one pull-up transistor and less than all of the pull-down transistors are in the on-state.

16. The output driving circuit of claim 11, wherein the at least one pull-up transistor is a plurality of pull-up transistors,
the at least one pull-down transistor is a plurality of pull-down transistors,
the plurality of pull-up transistors and the plurality of pull-down transistors are split transistors, the individual split transistors of the plurality of pull-up transistors sized according to a first size determination rate and the individual split transistors of the plurality of pull-down transistors sized according to a second size determination rate,
the output driving circuit is configured so that during a period in which a horizontal synchronization signal is active the plurality of pull-down transistors and the plurality of pull-up transistors are each in an on-state and performing a driving operation, and
during a period in which the horizontal signal is inactive, less than all of the plurality of pull down transistors and the plurality of pull-up transistors are in the on-state.

17. The output driving circuit of claim 16, wherein the first size determination rate and the second size determination rate are different.

18. The output driving circuit of claim 16, wherein the at least one cutoff MOS transistor is a plurality of cutoff MOS transistors,
the at least one switch is a plurality of switches, and
each of the plurality of pull down transistors and the plurality of pull up transistors that are in an off-state during the period in which the horizontal signal is inactive are connected to a corresponding one of the plurality of switches and a corresponding one of the plurality of cutoff MOS transistors.
